(19) United States
(12) Patent Application Publication
(10) Pub. No.: US 2003/0014722 A1
(43) Pub. Date: Jan. 16, 2003

(54) Automatic layout design method of wirings in semiconductor integrated circuit

(76) Inventors: Taizo Munemura, Hadano (JP); Masato Mogaki, Hadano (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/188,838

(22) Filed: Jul. 5, 2002

(30) Foreign Application Priority Data
Jul. 12, 2001 (JP) 2001-211642

(51) Int. Cl. G06F 9/45; G06F 17/50

(52) U.S. Cl. 716/8

(57) ABSTRACT

The present invention provides a method for completing detailed wiring of a semiconductor integrated circuit as intended by the layout designer in a short period of time. The method comprises the steps of: determining a floor plan of a semiconductor integrated circuit chip; displaying the floor plan with lattice lines superimposed thereon; if unit coordinate areas (lattice fields) included in a target interblock net and the order in which they are traced are specified, setting the coordinate values of the lattice fields and the order as a rough wiring path, the unit coordinate areas being defined by neighboring lattice lines; determining detailed layouts of gates; and performing automatic detailed wiring on condition that the target interblock net goes through the set rough wiring path (exists within the set rough wiring path).

### BACKGROUND OF THE INVENTION

The present invention relates to an automatic layout design method of wirings in a semiconductor integrated circuit.

In designing a chip layout of a semiconductor integrated circuit, a floor plan is designed at a step in the upstream stage as described in Japanese Laid-Open Patent Publications Nos. 8-44784 (1996) and 2000-222451. A floor plan (floor planning) is a process of determining the layout area for each logic block and the layout position of each fixed component, such as a RAM, in a semiconductor integrated circuit. In the floor planning process, wiring channels (wiring areas) are set for the interblock wiring between individual components as described in Japanese Laid-Open Patent Publication No. 11-307637 (1999). However, if automated detailed wiring is employed in the subsequent detailed interblock wiring process, the wiring algorithm may not effectively use the wiring channels set in the floor planning process, resulting in adoption of wiring channels different from those originally intended by the layout designer. On the other hand, Japanese Laid-Open Patent Publication No. 10-125789 (1998) discloses a wiring design method using an interactive editor. In this method, the user specifies interblock wiring paths, making it possible to utilize the wiring channels (wiring areas) set in the floor planning process. However, the wiring design method is disadvantageous when the wiring patterns are edited in finer coordinates since many nets must be processed, which requires a large number of man hours.

### SUMMARY OF THE INVENTION

With above conventional technique, if the detailed wiring between the logic blocks is automated, some wiring paths may be left undetermined when the wiring patterns are fine or complicated. In such a case, it is necessary to manually set portions of the wiring paths again by use of a wiring editor, increasing the man hours. On the other hand, manually setting all the wiring paths between the logic blocks requires a large number of man hours.

The present invention has been devised in order to solve the above problems. It is, therefore, an object of the present invention to provide a wiring path setting method for completing detailed wiring as intended by the layout designer in a short period of time.

A method of the present invention for setting wiring paths in a semiconductor integrated circuit having a plurality of logic blocks comprises: creating a floor plan which sets layout areas for the plurality of logic blocks on the semiconductor integrated circuit, and storing the created floor plan in a storage means; on a display, displaying the floor plan with lattice lines superimposed thereon; if one or more unit coordinate areas (lattice fields) included in an interblock net and an order in which the one or more unit coordinate areas are traced are specified, storing information on a rough wiring path into a storage means in such a way that the information is associated with the interblock net, the one or more unit coordinate areas being defined by neighboring lattice lines, the interblock net connecting between a first logic element within a first logic block and a second logic element within a second logic block, the first and second logic blocks being among the plurality of logic blocks, the rough wiring path indicating coordinate values of the one or more unit coordinate areas and the order; and performing detailed wiring processing on condition that the interblock net goes through the rough wiring path (exists within the rough wiring path), and storing information on a detailed wiring path obtained as a result of the processing into a storage means.

### BRIEF DESCRIPTION OF DRAWINGS

FIG. 1 is a diagram showing a chip floor plan according to an embodiment of the present invention;

FIG. 2 is a diagram in which the chip of the embodiment is divided by a lattice having a certain pitch;

FIG. 3 is a diagram showing an example of how an interblock net is connected;

FIG. 4 is a diagram showing the areas included in an interblock net and the order in which they are traced;

FIG. 5 is a diagram showing gate layouts within blocks;

FIG. 6 is a diagram showing an example of automatic detailed wiring;

FIG. 7 is a diagram showing the configuration of a computer according to the embodiment; and

FIG. 8 is a diagram showing a processing procedure for setting wiring paths according to the embodiment.

### DESCRIPTION OF THE PREFERRED EMBODIMENTS

Detailed description will be made below of a method for setting wiring paths according to an embodiment of the present invention with reference to the accompanying drawings.

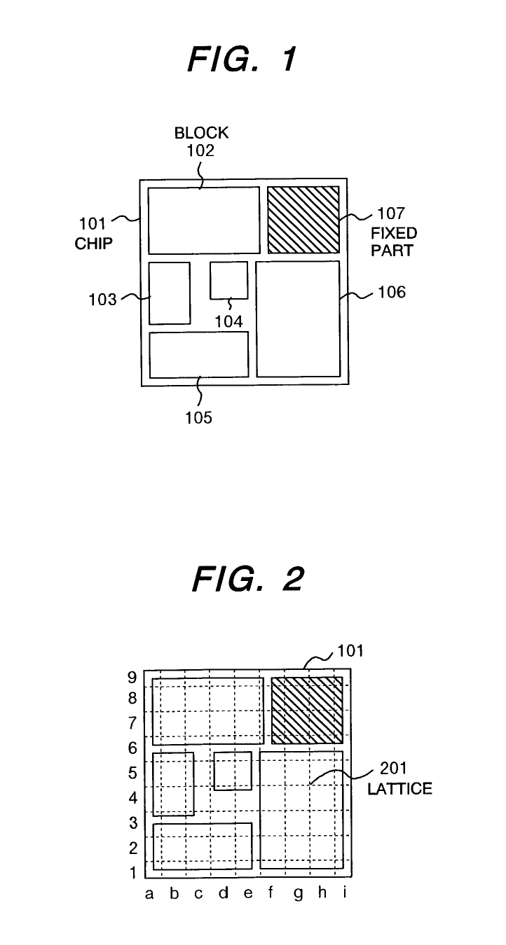

FIG. 1 shows a chip floor plan for a semiconductor integrated circuit. The floor plan of the semiconductor integrated circuit chip 101 determines the layout areas for logic blocks 102 to 106 and the layout position of a fixed part 107 such as a RAM.

FIG. 2 is a diagram in which the semiconductor integrated circuit chip 101 is divided by a lattice 201 having a certain pitch and disposed at a certain position. The positions and the pitches of the vertical and horizontal lines constituting the lattice 201 are specified by the user. Specifically, FIG. 2 shows a lattice which divides the chip into 81 portions (9 rows and 9 columns).

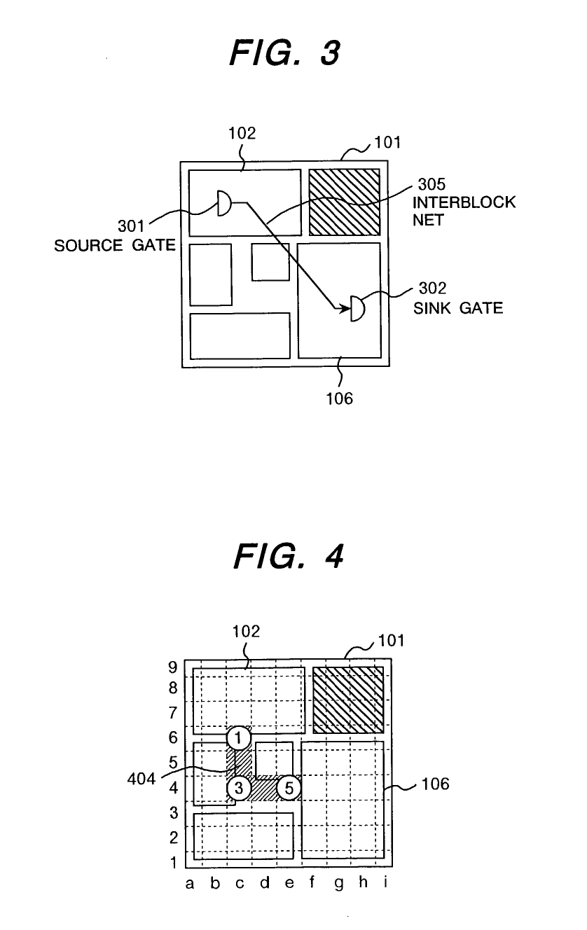

FIG. 3 shows how an interblock net is connected. Specifically, FIG. 3 shows an interblock net 305 which connects a source gate 301 in the logic block 102 to a sink gate 302 in the logic block 106.

FIG. 4 shows the areas included in the interblock net and the order in which they are traced (the interblock net wiring goes through the areas). The user specifies the coordinates of at least one position in each unit coordinate area (each lattice field defined by neighboring lattice lines) included in the interblock net 305 and the order in which each area is traced. In the figure, the net includes five lattice fields, and the x and y coordinates of the first to fifth lattice fields are set to be “(c,6)”, “(c,5)”, “(c,4)”, “(d,4) “, and” (e,4)”, respectively. The shaded portion in the figure indicates a rough wiring path 404 of the interblock net 305. The above given information is used in the subsequent automatic detailed layout and automatic detailed wiring processes.

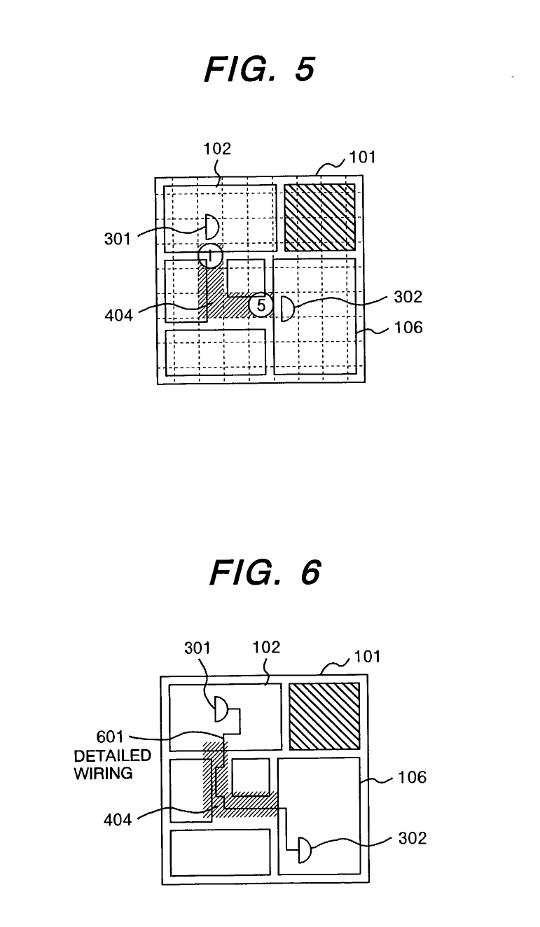

FIG. 5 is a diagram showing gate layouts within blocks. The source gate 301 is disposed near the first lattice field in the rough wiring path 404 of the interblock net 305. The sink gate 302, on the other hand, is disposed near the last (that is, fifth) lattice field of the rough wiring path 404.

FIG. 6 is an example of automatic detailed wiring. The automatic detailed wiring process generates a pattern for a detailed wiring path 601 based on given information on the rough wiring path 404 and the order of the lattice fields for the interblock net 305.

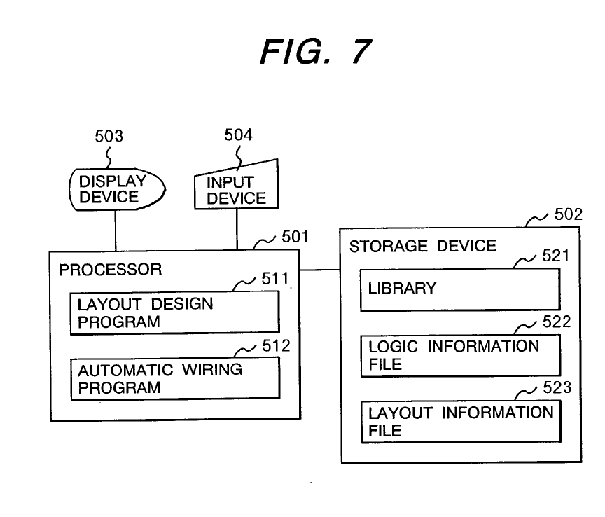

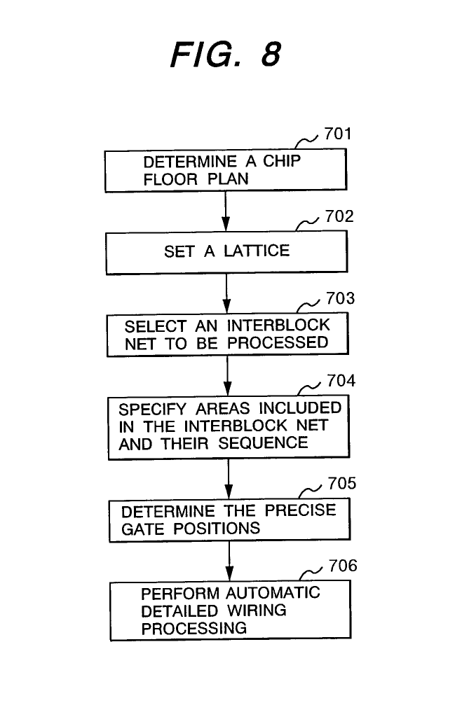

FIG. 7 is a diagram showing the configuration of a computer used to design the layout and the wiring of a semiconductor integrated circuit. The computer comprises a processor 501, a storage device 502, a display device 503, and an input device 504.

The storage device 502 stores a library 521, a logic information file 522, and a layout information file 523. The library 521 includes symbols of logic elements such as gates and symbols of fixed parts such as a RAM. The logic information file 522 contains tables which store the block name of each logic block on a chip, the logic element names of the logic elements in each block, the names of the wire connections connecting between the logic elements, and information on the wiring path of each wire connection. The layout information file 523 contains the layout position of each logic block on a chip, information on its dimensions, information on the layout position of each fixed part, and information on the layout positions of the logic elements in each logic block.

The memory in the processor 501 stores a layout design program 511 and an automatic wiring program 512 which are executed by the processor 501. The layout design program 511 displays a guidance screen on the display device 503, helps set the layouts of components on a chip, such as logic blocks and gates, and stores prepared layout information in the layout information file 523. Furthermore, the layout design program 511 helps set a rough wiring path for each interblock net based on the layout information, and stores information on the set wiring path into a corresponding table of the logic information file 522. The automatic wiring program 512, on the other hand, retrieves information on the rough wiring path of each interblock net from the logic information file 522 to carry out detailed wiring, and stores the processing results in a corresponding table of the logic information file 522.

FIG. 8 is a diagram showing a processing procedure for setting wiring paths of a semiconductor integrated circuit. First of all, a chip floor plan is determined at step 701. The layout design program 511 displays a guidance screen on the display device 503. On the display screen, the user specifies the layout position and dimensions of each logic block on a chip as well as the layout positions of fixed parts such as RAMs through the input device 50. Upon receiving the given information, the layout design program 511 prepares layout information and stores it in the layout information file 523. At step 702, the layout design program 511 sets a lattice (grid) used as a reference for setting a rough wiring path on the chip floor plan created at step 701. The layout design program 511 retrieves layout information on a specified chip from the layout information file 523 and displays it on the display device 503. After the positions and pitch of lattice lines are given through the input device 504, or parameters indicating them are input from a file (not shown) the layout design program 511 displays the floor plan with gird lines as shown in FIG. 2 superimposed thereon.

An interblock net to be processed is selected at step 703. Based onauser's instruction, the layout design program 511 retrieves from the logic information file 522 wire connection information including the name of the wire connection connecting between the source gate 301 in the logic block 102 and the sink gate 302 in the logic block 106, and displays the retrieved information on the display device 503. When the user has entered the name of a desired wire connection by use of the input device 504, its interblock net is selected as a target to be processed. Then, the user specifies the areas included in the selected interblock net and the order in which they are traced, at step 704. Specifically, when the user has specified a rough wiring path expressed by a series of the coordinates of the grid fields traced by the wiring as shown in FIG. 4, the layout design program 511 adds information on the rough wiring path to the table for the selected interblock net.

After the rough wiring path has been thus set on the chip, detailed layouts of the gates are determined at step 705. The layout design program 511 determines the position of the source gate 301 within the logic block 102 and the position of the sink gate 302 within the logic block 106 by use of a known algorithm, and stores information on the determined positions into the layout information file 523 as information on the gates.

Then, the automatic wiring program 512 retrieves information on the rough wiring path set at step 704 from the layout information file 523 and performs automatic detailed wiring processing at step 706. The automatic wiring program 512 further divides the lattice (lattice) set at step 702 to produce a lattice having a finer pitch, and performs detailed wiring of each interblock net using the produced lattice as a reference. The automatic wiring program 512 then stores wiring information on each wire connection obtained as a result of the above processing into a corresponding table of the logic information file 522. Conventional automatic detailed wiring can be carried out with a high degree of freedom since no rough wiring path of the present invention is given beforehand. According to the present invention, however, the automatic wiring algorithm is created on condition that the automatic detailed wiring be set within the rough wiring path. Therefore, the position of the detailed wiring (path) of each interblock net is limited to within the set rough wiring path.

According to the present invention described above, since the wiring path of each interblock net can be set as intended by the layout designer, it is possible to utilize the wiring areas for interblock nets set at the time of floor planning. Furthermore, after specifying the lattice fields constituting a rough wiring path, the user can leave the further wiring to an automatic detailed wiring process, resulting in reduced man hours as compared with the conventional technique and making it possible to set the wiring paths of a high-performance semiconductor integrated device in a short period of time.

What is claimed is:

1. A method for setting wiring paths in a semiconductor integrated circuit having a plurality of logic blocks, said method comprising the steps of:
creating a floor plan which sets layout areas for said plurality of logic blocks on said semiconductor integrated circuit, and storing said created floor plan in a storage means;
on a display, displaying said floor plan with lattice lines superimposed thereon;
if one or more unit coordinate areas (lattice fields) included in an interblock net and an order in which said one or more unit coordinate areas are traced are specified, storing information on a rough wiring path into a storage means in such a way that said information is associated with said interblock net,
said one or more unit coordinate areas being defined by neighboring lattice lines,
said interblock net connecting between a first logic element within a first logic block and a second logic element within a second logic block, said first and second logic blocks being among said plurality of logic blocks,
said rough wiring path indicating coordinate values of said one or more unit coordinate areas and said order; and
performing detailed wiring processing on condition that said interblock net goes through said rough wiring path (exists within said rough wiring path), and storing information on a detailed wiring path obtained as a result of said processing into a storage means.

2. The method as claimed in claim 1, wherein said lattice lines on said floor plan are set to have positions and a pitch specified by a user. 3.

3. The method as claimed in claim 1, wherein said information on said rough wiring path and said information on said detailed wiring path are stored in a logic information file.

4. A computer-readable storage medium storing a program which causes a computer to perform the steps of:
on a display, displaying a floor plan with lattice lines superimposed thereon, said floor plan setting layout areas for a plurality of logic blocks on a semiconductor integrated circuit;
if one or more unit coordinate areas (lattice fields) included in an interblock net and an order in which said one or more unit coordinate areas are traced are specified, storing information on a rough wiring path into a storage means in such a way that said information is associated with said interblock net,
said one or more unit coordinate areas being defined by neighboring lattice lines,
said interblock net connecting between a first logic element within a first logic block and a second logic element within a second logic block, said first and second logic blocks being among said plurality of logic blocks,
said rough wiring path indicating coordinate values of said one or more unit coordinate areas and said order; and
performing detailed wiring processing on condition that said interblock net goes through said rough wiring path (exists within said rough wiring path), and storing information on a detailed wiring path obtained as a result of said processing into a storage means.

5. The computer-readable storage medium as claimed in claim 4, wherein said lattice lines on said floor plan are set to have positions and a pitch specified by a user.

6. A method for automatically setting wiring in a semiconductor integrated circuit having a plurality of blocks, said method comprising the steps of:
determining a floor plan which sets layout areas for said plurality of blocks on said semiconductor integrated circuit;
on said floor plan, setting a plurality of lattice lines at predetermined positions with a predetermined pitch;
selecting an interblock net to be processed;
specifying areas included in said selected interblock net by use of a rough wiring path expressed by a series of coordinate values of unit coordinate areas defined by said plurality of lattice lines, said rough wiring path indicating an order in which said areas are traced; and
performing automatic detailed wiring of said interblock net on condition that said interblock net goes through said rough wiring path (exists within said rough wiring path).

7. The method as claimed in claim 6, wherein said series of coordinate values are a series of coordinate values of turning points of said path.

8. The method as claimed in claim 6, wherein said lattice lines on said floor plan are set to have positions and a pitch specified by a user.

9. A program for executing the method as claimed in claim 6.

10. A computer-readable storage medium storing a program which causes a computer to perform the method as claimed in claim 6.
